(19) United States
(12) Patent Application Publication
(10) Pub. No.: US 2023/0328849 A1
(43) Pub. Date: Oct. 12, 2023

(54) SPORTS EQUIPMENT THERMAL REGULATION DEVICES, SYSTEMS, AND METHODS

(71) Applicant: Bat Cozy, LLC, Orange, CA (US)

(72) Inventor: David Carrillo, Orange, CA (US)

(21) Appl. No.: 18/181,223

(22) Filed: Mar. 9, 2023

Related U.S. Application Data
(60) Provisional application No. 63/362,573, filed on Apr. 6, 2022.
(60) Provisional application No. 63/363,368, filed on Apr. 21, 2022.

(51) Int. Cl. H05B 3/58; A63B 60/60

(52) U.S. Cl. CPC H05B 3/58; A63B 60/60; A63B 2102/18

(57) ABSTRACT

Various apparatuses for heating sport equipment, such as baseball and softball bats, are disclosed. The heating apparatus may include a sleeve having a bottom surface. A heating element may be attached to the interior of the sleeve. The heating apparatus can include a wrap that provides mechanical tension against the sport equipment. The heating apparatus can include a pocket for an energy source that provides power to the interior heating element.

### CROSS REFERENCE

This application claims the priority benefit of U.S. Provisional Patent Application No. 63/362,573, filed Apr. 6, 2022, and U.S. Provisional Patent Application No. 63/363,368, filed Apr. 21, 2022, the entirety of each of which is incorporated by reference herein. All applications for which a foreign or domestic priority claim is identified in the associated Application Data Sheet are hereby incorporated by reference under 37 CFR 1.57.

### BACKGROUND

### Field

This disclosure relates to a portable device and system for warming sports equipment, such as a baseball bat or softball bat. Although certain embodiments and features of the present disclosure is described herein with respect to a baseball or softball bat, the scope of the present disclosure is not limited to baseball or softball bats and includes other sport equipment.

### Certain Related Art

Sport equipment includes various articles used in or around, such as in preparation of, sporting events or activities. Some sport equipment is designed to contact another object, such as a bat that is used to hit a baseball or softball. Such sport equipment is generally constructed from composite materials, metal, or wood. The performance and structural integrity of the sport equipment can be degraded when exposed to, and used in, cold ambient temperatures. For example, bats constructed of composite materials can be prone to performance degradation and cracking when used in cold temperatures. Delamination of the composite materials may occur when the bat is used in temperatures of less than or equal to about 65° F.

### SUMMARY OF CERTAIN FEATURES

A solution is needed that addresses the performance and structural integrity issues, or other issues, by providing thermal regulation (e.g., warming) of the bat. While some devices offer methods for warming bats in limited circumstances, they suffer from multiple concerns, which have not been adequately addressed.

One concern relates to the portability of the devices. For example, a device that requires a corded plug to be inserted into a typical electrical wall outlet limits the ability of the device to be moved to the length of the cord. Moreover, when the device is unplugged the device no longer operates and the bat cools.

Another concern is the method and/or location of the transfer of heat energy to the bat. Some devices utilize convection heat sources positioned below and/or at a distal end of the bat(s). This generally results in varying, inadequate temperatures around the bat barrel (which may include the “sweet spot” of the bat) and/or excessive heat at a distal end of the bat(s). This may be because heat transfer relies on passive conduction through the bat material and not immediate contact of heat source throughout the barrel.

Another concern relates to the use of pre-heated elements (e.g., elements heated in a microwave), which are only capable of providing heat for a limited amount of time. Also, microwave ovens are typically not available in baseball/softball field dugouts. As a result, these devices may decrease or stop providing heat to the bat as time elapses (e.g., travel to field, delays in event start time, extended time of events).

Another concern is the type of power used and the requirement for sources of energy that are not generally available at the field of play, such as at a baseball or softball diamond in a typical community park in which amateur events are normally held. A device that requires a 120-volt power source is inconvenient because power outlets may not be readily available near the field of play, such as in dugouts. In addition, devices that utilize multiple disposable (e.g., AA) batteries only provide a limited amount of power, and thus heat. Furthermore, the substantial drain on the low voltage disposable batteries forces a user to frequently change them for fresh batteries and requires carrying additional batteries.

Another concern is the method by which the heat energy is transferred to the bat. A device that uses convection or radiation to transfer thermal energy to the bat may be less efficient than a device that uses conduction to transfer thermal energy to the bat. A device that loosely receives the bat may be less efficient in conveying heat to the bat than a device that tightly receives the bat.

Another concern is security and size. A bat heating device that loosely receives the bat may not adequately secure the bat, which could lead to reduced heat transfer, to the bat shifting within the device (such as bumping against the sides) during transport, and/or to dislodgement of the bat from the device. As a bat heating device increases in size, so can the difficulty of installing the device in other articles (such as an equipment bag, bat bag, bat pack, etc.) and/or the amount of space occupied by the device (such as more space in such articles and less space for other articles).

The present disclosure relates to a thermal regulation device (also called a heating apparatus or bat warmer) that solves one or more of the aforementioned concerns and limitations, or other concerns and limitations. Various embodiments of the heating apparatus provide portability, increased performance, and/or ease of use.

The heating apparatus can include a sleeve. The sleeve can have a cavity configured to receive a bat or other sport equipment. The sleeve can be generally cylindrical or another shape. The heating apparatus can include a heating unit and/or a rechargeable portable power bank, such as a battery. The heating apparatus can apply mechanical force (e.g. compression and/or tension) to the sleeve and/or bat or other sport equipment. The force can be provided by a wrap that can be partially or completely wrapped around (e.g., circumferentially surround) the sleeve. In some implementations, a tensile force applied to the wrap may be applied or converted to a compressive force on the sleeve and/or bat or other sport equipment. The force may compress (e.g., radially inwardly) the sleeve and/or the heating unit (e.g., heating coils) against (e.g., directly against) the sport equipment to transfer heat to an action area of the sport equipment, such as the barrel of a bat. In The action area of the sport equipment can be the general area where the sport equipment is intended to contact another object, such as the general area on a barrel of a bat that is intended to make contact with a ball. The sport equipment may comprise a handle and/or a grip point. The handle and/or grip point of the sport equipment can be left exposed, not within the sleeve, and/or not in contact with the heating unit.

The heating apparatus can include a fastening element, such as a zipper. The fastening element can facilitate (e.g., increase the opening size) inserting the sport equipment (such as a baseball bat or softball bat) into the cavity. In some embodiments, the fastening element can aid in retaining heat when the zipper is closed, as it forms a taper of the cavity. The heating apparatus can be adapted to operate independently and/or may not depend on the zipper to provide mechanical tension. The heating apparatus can be adapted to operate with the zipper in the open position or closed position. In some embodiments, the heating apparatus can apply mechanical force (e.g. compression and/or tension) on the bat, such as using the wrap. In some embodiments, the heating apparatus can include connectors, such as fence clips. The connectors can be positioned, for example, at the top and/or bottom of the sleeve to accommodate attaching the invention to a structure, such as a chain-link fence, for ease of use during a sporting event, during storage, or otherwise.

The heating apparatus may include an electrically powered heating unit adapted to warm a bat above ambient temperature. The heating unit can include, for example, one or more heating coils, heating strips, heating rings, etc. In some embodiments, the heating unit is in the sleeve. In some embodiments, the heating unit is positioned on an inner wall of the sleeve and/or radially inward of the sleeve.

The heating apparatus may include a power source. The power source can be, for example, a rechargeable battery, such as a battery used to charge cell phones to provide an electrical current to the heating unit. The power source can include a battery pack, which can include one or more batteries.

The heating apparatus can include a mechanical wrap. The warp can be adapted to wrap around and/or compress the sleeve around the bat. In some implementations, the compression of the sleeve facilitates or acts to place the heating unit in contact (e.g., direct contact) with the bat.

The heating apparatus can include one or more controls. For example, the heating apparatus may provide an illuminated on/off button to provide a visual indicator to a user that the device is in operation or turned off.

In some implementations, the heating apparatus comprises a bat warmer. The bat warmer can comprise a sleeve. The sleeve can be configured to receive a bat. The bat warmer can have a heater on an interior of the sleeve. The heater can be configured to apply (e.g. through heating coils, heating strips) thermal energy to the bat in the sleeve. The bat warmer can comprise a wrap. The wrap can comprise a first end and a second end. The first end can be connected (e.g., sewed, attached with adhesive, etc.) to the sleeve. The second end can be located opposite the first end. The second end can be a free end. The second end can be configured to wrap around an exterior of the sleeve. The second end can be configured to wrap around the exterior of the sleeve such that the wrap applies compressive force to the sleeve, the heater, and the bat in the sleeve.

In some embodiments, the first end of the bat warmer can comprise one of a hook and a loop. The second end can comprise the other of the hook and the loop. The hook and the loop can form a fastening system (e.g., Velcro®) to connect the wrap to itself.

In some embodiments, the sleeve of the bat warmer can be made from neoprene.

In some embodiments, the heater of the bat warmer can directly contact the bat.

In some embodiments, the second end of the bat warmer can comprise a pocket. The pocket can be configured to receive a power source (e.g. battery) for powering the heater.

Some implementations include a combination of the bat warmer and the bat. This combination can be part of a kit. The kit may include a battery, plug, or other components.

Another aspect of the present disclosure is a heating apparatus for warming a sport equipment. The heating apparatus can comprise an electric heater. The electric heater can be configured to apply thermal energy to the sport equipment during operation of the heating apparatus. The heating apparatus can comprise a battery. The battery can be operably connected (e.g., wirelessly, through conductors, etc.) to the electric heater so as to provide electric power to the electric heater during operation of the electric heater. The heating apparatus can comprise a compression sleeve. The compression sleeve can be configured to receive the sport equipment. The compression sleeve can provide a first stage of force to press the electric heater against the sport equipment. The heating apparatus can comprise a wrap. The wrap can comprise a first end. The first end can be attached to the compression sleeve. The wrap can comprise a free second end opposite the first end. The wrap can be configured to provide a second stage of force to press the electric heater against the sport equipment.

In some embodiments, the heating apparatus can further comprise a user interface. The user interface can be connected (e.g., wirelessly, through conductors, etc.) to the electric heater. The user interface can be configured to control an operation of the electric heater in response to an input by a user.

In some embodiments, the heating apparatus can have a compression sleeve. The compression sleeve can comprise a top end. The top end can have an opening. The top end can also have an adjustable fastening system. The adjustable fastening system can be configured to adjust (e.g., increase or decrease) a size of the opening.

In some embodiments, the electric heater of the heating apparatus can be positioned in an interior of the compression sleeve.

In some embodiments, the free second end of the wrap can be connected to the first end of the wrap when heating device of the heating apparatus is in use.

In some embodiments, the electric heater can directly press against the sport equipment.

In some embodiments, the sport equipment can be a baseball bat or softball bat.

In some embodiments, the user interface can illuminate when the electric heater is in use.

In some embodiments, the adjustable fastening system can be a zipper.

Some embodiments of the heating apparatus can be a combination comprising the heating apparatus and the sport equipment.

Another aspect of the present disclosure can be a sport equipment warming assembly. The warming assembly can comprise a compression sleeve. The compression sleeve can be configured to receive a generally cylindrical portion of a sport equipment. The compression sleeve can comprise a bottom portion, a top portion, and a middle portion connecting the top portion to the bottom portion. The sport equipment warming assembly can comprise a heater. The heater can be connected to the compression sleeve. The sport equipment warming assembly can comprise a wrap. The wrap can comprise a first end attached to the middle portion of the compression sleeve. The wrap can comprise a second end opposite the first end. The second end can be configured to wrap around the compression sleeve, the heater, and the generally cylindrical portion of the sport equipment. The wrap can be attached to the first end.

In some embodiments, the second end of the sport equipment warming assembly can comprise a pocket.

In some embodiments, the sport equipment warming assembly can comprise a battery. The battery can be positioned in the pocket. The battery can be configured to provide electric power to the heater.

In some embodiments, the heater of the sport equipment warming assembly can abut (e.g. directly or indirectly contact) the generally cylindrical portion of the sport equipment.

Other objectives and advantages will become apparent from the following description taken in conjunction with the accompanying drawings wherein are set forth, by way of illustration and example, certain embodiments. The drawings constitute part of this specification and illustrate various objects and features thereof.

For purposes of summarizing the disclosure, certain aspects, advantages, and features of the technology have been described above. Not necessarily any or all such advantages are achieved in accordance with any particular embodiment of the technology disclosed herein. No aspects of this disclosure are essential or indispensable. Neither the preceding summary nor the following detailed description purports to limit or define the scope of protection. The scope of protection is defined by the claims.

### BRIEF DESCRIPTION OF THE DRAWINGS

Certain features of this disclosure are described below with reference to the drawings. The illustrated embodiments are intended to illustrate, but not to limit the embodiments. Various features of the different disclosed embodiments can be combined to form further embodiments, which are part of this disclosure.

FIG. 1A illustrates a perspective view showing a front of an embodiment of the heating apparatus;

FIG. 1B illustrates a perspective view showing a back of the heating apparatus of FIG. 1A;

FIG. 2A illustrates a cross-section of the heating apparatus of FIG. 1A with a bat inserted;

FIG. 2B illustrates a cross-section of a sleeve of the heating apparatus of FIG. 1A;

FIG. 3A illustrates a front view of a mechanical wrap of the heating apparatus of FIG. 1A;

FIG. 3B illustrates a cross-section of the mechanical wrap of the heating apparatus of FIG. 1A;

FIG. 3C illustrates a cross-section of the heating apparatus of FIG. 1A from a top view;

FIG. 4 illustrates a heating unit of the heating apparatus of FIG. 1A; and

FIGS. 5, 6, and 7 illustrate the heating apparatus of FIG. 1A in various stages of operation.

### DETAILED DESCRIPTION OF CERTAIN EMBODIMENTS

Various sport equipment heating apparatuses, systems, and methods are described. Certain embodiments are described in the context of a heating apparatus configured to heat a baseball or softball bat, due to particular utility in that context. However, the technology disclosed herein can also be applied to other types of sport equipment, such as cricket bats, tennis or badminton rackets, pickleball paddles, golf clubs, lacrosse or field hockey sticks, skis and poles, balls (e.g., baseballs, softballs, footballs, basketballs, soccer balls, tennis balls, golf balls, etc.), helmets, or otherwise. No features, structure, or step disclosed herein is essential or indispensable.

### Overview

Referring generally to the figures, a heating apparatus 10 for warming a sport equipment 1, such as a baseball or softball bat, is shown. The heating apparatus 10 can also be called a bat warmer. The heating apparatus 10 can include a sleeve 11 having a body 11a and an interior cavity 11b sized and shaped to receive the sport equipment 1, such as the softball or baseball bat. One end of the sleeve 11 may be closed or selectively closable, such as a distal end 23. A proximal end 31 of the sleeve 11 may be open and/or selectively openable. As discussed in more detail below, the sleeve 11 may be configured to expand and contract around the exterior of the sport equipment 1. As illustrated, in some implementations, the sleeve 11 is generally cylindrical in shape. In several embodiments, the heating apparatus 10 does not fully enclose the sport equipment 1. For example, as illustrated, the handle of the sport equipment 1 can protrude out of the heating apparatus 10.

The top and/or bottom of the sleeve 11 can include a connector 20, which can enable the heating apparatus 10 to be removably connected (e.g., to a fence or screen) for ease of use and storage. For example, using the connector(s) 20, the heating apparatus 10 can be hung on a chain-link fence during a sporting event. The connector 20 can include a latch, loop, clasp, etc.

The heating apparatus 10 can include a heating unit 16 (also called a heater). The heating unit 16 can be arranged to transmit heat to an action area 28 of the sport equipment 1. The heating unit 16 can be operably connected with a user interface 19, such as an on-off toggle, to activate or deactivate the heating unit 16.

Certain embodiments of the heating apparatus 10 include a mechanical wrap 24. The mechanical wrap 24 may include a flexible elongate member, such as a strap. The mechanical wrap 24 may include a flexible fabric body and may be attached to the exterior of the sleeve 11. The wrap 24 can be configured to partially or completely surround an exterior circumference of the sleeve 11. The wrap 24 can provide compression of the heating unit 16 against the sport equipment 1. The mechanical wrap 24 can include a fastener that can secure the mechanical wrap 24 in position, such as relative to the sleeve 11. This can facilitate maintaining mechanical tension around the sleeve 11 and/or providing compression of the heating unit 16 against the sport equipment 1. In some embodiments, the fastener comprises a hook 13 and loop 14a fastening system, snaps, hooks, cinch, or otherwise. In certain variants, the mechanical wrap 24 engages with a fastener (e.g., buckle, latch, clasp, etc.) on the sleeve 11. In several implementations, the wrap 24 can be secured to and/or tensioned about the sleeve 11, such as to squeeze the sleeve 11.

The mechanical wrap 24 can include a pocket 25 for holding a power source 18, such as a battery. The pocket 25 can be configured to enable the battery to be installed or removed from the pocket 25, such as through an open top of the pocket 25. In some embodiments, the pocket 25 is selectively closable, such as with a zipper or other fastening device.

The mechanical wrap 24 may include a pocket face 12a having elastic fabric that can further facilitate the expansion and contraction of the cavity of the heating apparatus 10 during the insertion and removal of the sport equipment 1. The pocket face 12a having an elastic fabric may form a part of the mechanical wrap 24 and form the pocket 25 for holding the power source 18. The pocket face 12a having elastic fabric can facilitate the insertion and removal of various sizes of the power source 18.

As mentioned above, the heating apparatus 10 can include the user interface 19, which can be externally positioned. In some embodiments, the user interface 19 is on the sleeve 11. In some embodiments, the user interface 19 is on the wrap 24. For example, the mechanical wrap 24 may include an external, illuminated user interface 19 that visibly notifies the user that the heating apparatus 10 is in operation (illuminated) or not in operation (not illuminated) or vice versa. The external user interface 19 can signify to the user that the power source 18 has been depleted and may need recharging or replacement. The flexible fabric of the body 11a may provide protection of the wires coming from the heating unit 16 and the internals of the user interface 19 from damage. The mechanical wrap 24 may contain markings or other indicia on the exterior, such as a player's name, a player's number, or other markings, that can aid the user in quickly identifying their heating apparatus 10.

### Sleeve

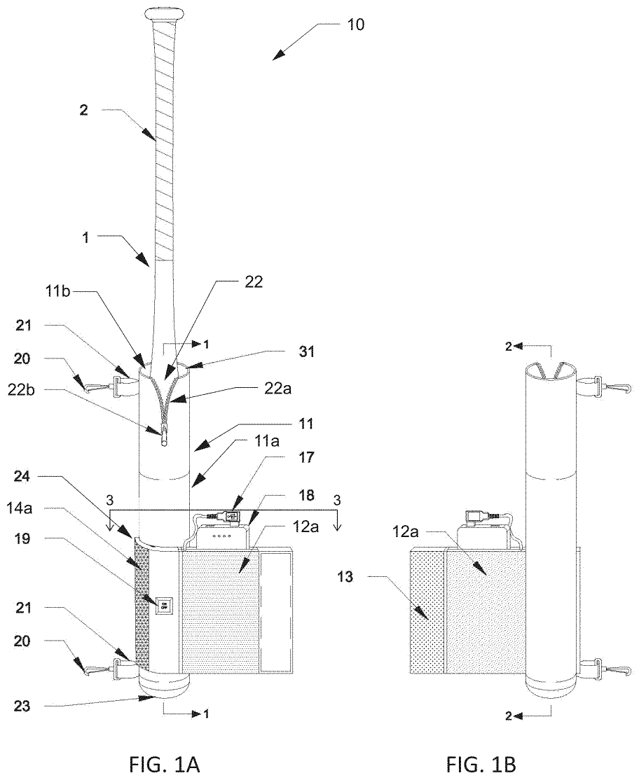

As mentioned above, and as illustrated in FIG. 1A, the heating apparatus 10 can include the sleeve 11. The sleeve 11 can include the body 11a. The sleeve 11 can have the proximal end 31 and the distal end 23. The sleeve 11 can be designed to receive a sport equipment and can be designed to take the shape of the desired sport equipment. For example, the sleeve 11 can be designed to take a cylindrical shape to accommodate receiving a generally cylindrical sport equipment, such as a baseball or a softball bat.

The body 11a can have a cross-section with various diameters to accommodate the receiving equipment. For example, a cylindrically-shaped body 11a can have a diameter of about between 1 inch to 2 inches, or about between 2 inches and 3 inches, or about between 3 inches to 4 inches, or about between 4 inches to 5 inches, or about between 5 inches to 6 inches, or any size between 1 inch to 6 inches. In some embodiments, the diameter of the body 11a can be smaller than 1 inch or larger than 6 inches, or it can be an increment of any number between 1 inch to 6 inches. For example, it can be 2⅝″ or 3¼″. It can also be an increment of any number smaller than 1 inch or larger than 5 inches. In some embodiments, a body 11a can have varying diameters and different cross-sections throughout its length. For example, in some embodiments, the cross-section of the body 11a can be larger at the bottom and smaller on top or vice versa. In some embodiments, the body 11a is not cylindrical, or it does not have a cylindrical cross-section. For example, the body 11a can take other shapes to accommodate other sport equipment, such as a cricket racket, tennis racket, squash racket, badminton racket, or any other sport equipment that could benefit from the warming functionality of the heating apparatus 1.

The body 11a can have various lengths to accommodate the desired sport equipment 1. The length of body 11a extends between the distal end 23, such as an end cap, and the proximal end 31 (also called the entrance 31). In some embodiments, the length of the body 11a can be about between 12 inches to 16 inches, or about between 20 inches to 24 inches, or about between 28 inches to 32 inches, or about between 32 inches to 36 inches. In some embodiments, the body 11a can be smaller than 12 inches or larger than 36 inches. In some embodiments, the body 11a can be an increment of any number between 12 inches to 36 inches, or it can be an increment of any number smaller than 12 inches or larger than 36 inches. For example, the body 11a can have a length of 24-½ inches or 36-¾ inches.

The sleeve 11 can be manufactured of various materials. The body 11a can also be manufactured from a combination of two or more different types of materials. In some embodiments, the body 11a can be made of neoprene. In some embodiments, other types of material (or a combination of different types of material) that can provide compression by compressing against the sport equipment 1 can be used. For example, the body 11a can be manufactured from different types of natural or synthetic rubbers. The sleeve 11 can be made of a rubber or fabric material, such as neoprene (polychloroprene), nylon, spandex, cotton, etc. In various embodiments, the sleeve 11 expands and contracts in response to insertion and withdrawal of the sport equipment 1. The sleeve 11 can be configured to receive and apply compressive force to the sport equipment 1. For example, the sleeve 11 can elastically expand to receive the sport equipment 1 and apply a radially-inward compressive restoring force against a barrel of the sport equipment 1. The sleeve 11 can be configured to thermally insulate the portion of the sport equipment 1 located inside the sleeve 11 from the ambient environment. For example, the sleeve 11 can have an R-value of at least about 0.054 (W/m.° C.). In some implementations, the sleeve 11 has an R-value of greater than or equal to about: 0.02 (W/m.° C.). 0.04 (W/m.° C.). 0.06 (W/m.° C.). 0.08 (W/m.° C.). 0.10 (W/m.° C.), or otherwise.

In some embodiments, the body 11a can include an opening 22. The opening 22 can accommodate the entry of the sport equipment 1, such as a baseball or softball bat. As shown, the opening 22 can be at the proximal end of the sleeve 11. In some variants, the opening 22 is at the distal end of the sleeve 11. Certain implementations include an opening 22 at the proximal and distal ends. In several implementations, the sleeve 11 is tapered. For example, the diameter of the sleeve 11 at the proximal end or distal end can be less than a diameter of the sleeve 11 at a midpoint along the length of the sleeve 11.

In some embodiments, the opening 22 can be selectively opened (e.g., expanded in size) or closed (e.g., reduced in size), such as with a fastening piece 22a. The fastening piece 22a can have a slider piece 22b. In some embodiments, the fastening piece 22a can be a zipper. In some embodiments, the fastening piece 22a includes an elastic mechanism, cinch cord, draw string, snaps, buttons, hook and loop fastener, or any other mechanism that allows for closing the opening 22 such that the opening 22 snugly fits around the sport equipment 1. For example, the fastening piece 22a can be designed so that the two ends of the opening 22 can snap together without utilizing the slider piece 22b. In certain embodiments, there is no fastening piece 22a (e.g., zipper) at the opening 22.

The sleeve 11 can include features to facilitate mounting, such as hanging, the heating apparatus 10. For example, the sleeve 11 can include at least one connector 20. As shown in FIG. 1A, connectors 20 may be attached to the heating apparatus 10 by a loop 21 in a location nearest the proximal end 31, or opening, of the sleeve 11 and a secondary connector 20 and loop 21 may be located near the distal end 23. In some embodiments, one or more connector(s) 20 can be attached to the heating apparatus 10 in other areas. For example, one or more connectors 20 can be attached to the heating apparatus 10 in the body 11a between the distal end 23 and the proximal end 31. The connector 20 can facilitate use by allowing the user to attach or secure the heating apparatus 10 to existing structures, such as a chain-link fence, commonly located near the field of play. Connectors 20 may be positioned near the proximal end 31 and distal end 23 which can allow the heating apparatus 10 to be attached to a structure, like chain-link fence, in a vertical orientation that further aids the user in the insertion and removal of the sport equipment 1 from the sleeve 11.

Still referring to FIG. 1A, the heating apparatus 10 can include a fastening element, such as a fastening piece 22a. The fastening piece 22a may facilitate the retention of heat when in the closed position as it forms a taper of the sleeve 11 at the proximal end 31 of the cavity. The heating apparatus 10 can operate independently and/or may not depend on the fastening piece 22a to provide mechanical tension and, therefore, can be operated with the fastening piece 22a in either the open or closed position. The fastening piece 22a may significantly increase the size of the proximal end 31 of the cavity to facilitate the insertion of the sport equipment 1. The fastening piece 22a as shown in FIG. 1A can allow ample expansion of the circumference at the bat's entry point to easily insert a bat into the cylinder, while not reducing the compression of the heat coils against the bat in other sections of the heating apparatus 10.

The overall size of the heating apparatus 10 can be kept to a minimum to facilitate portability and ease of use. The heating apparatus 10 can be sized to fit inside standard sports equipment bags, like backpack, bat pack, roller bag, or tote bag styles. This portability aids the player in not having additional sporting equipment and/or bags to carry to the playing field. In some embodiments, with the sport equipment 1 installed in the heating apparatus 10 and the heating apparatus 10 in operation heating the bat, the maximum outside diameter of the heating apparatus 10 (as a percentage of the diameter of the sport equipment 1) is less than or equal to about: 120%, 130%, 140%, 150%, or otherwise.

### Heating Unit

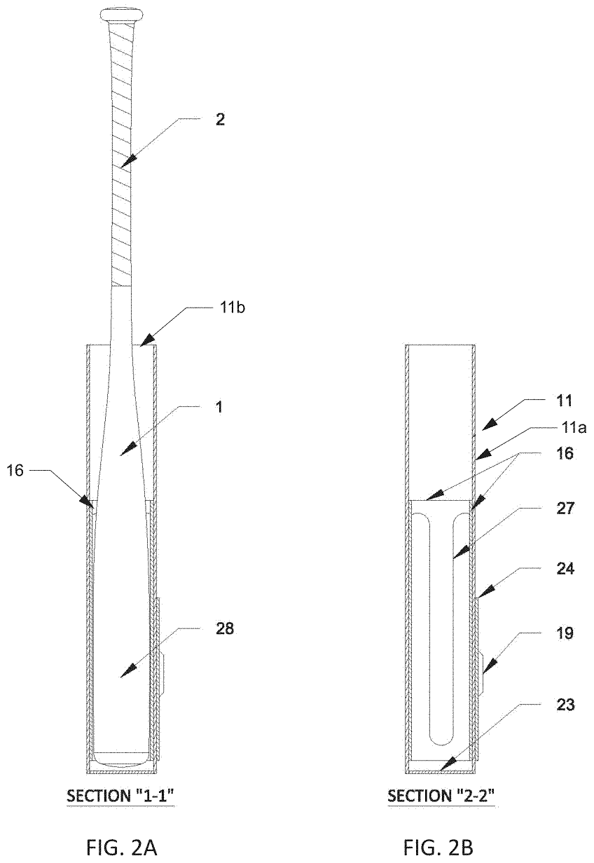

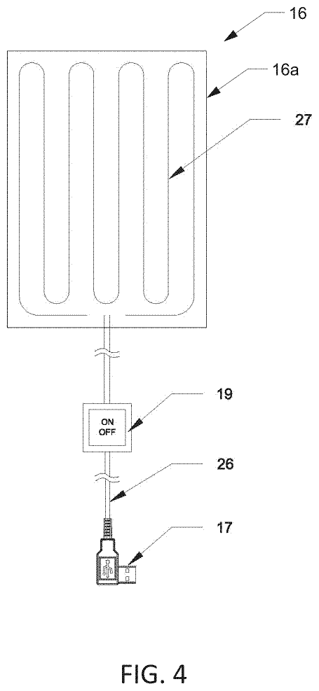

FIGS. 2B and 4 illustrate the heating unit 16. In some embodiments, the heating unit 16 can be positioned in the interior cavity space 11b of the sleeve 11. For example, as shown in FIG. 2B, the heating unit 16 can be positioned on an inner wall of the sleeve 11. This can enable the heating unit 16 to directly contact (e.g., abut) the sport equipment 1 and/or to adapt to the shape of the sport equipment 1, which can increase the heat transfer efficiency, rate, etc. In some embodiments, the sleeve 11 can have a cavity in the body 11a that will receive the heating unit 16, such as between inner and outer walls of the sleeve 11.

The heating unit 16 can include a heating element 27. The heating element 27 can provide the mechanism for providing heating to the sport equipment 1. In some embodiments, the heating element 27 can be an electric heating coil having various shapes, such as spiral coils, straight coils, or rectangular coils. In some embodiments, the heating element 27 can be manufactured from different types of metals, such as copper, aluminum, brass, bronze, steel or other types of non-metallic thermally conductive compounds and materials that can facilitate the transfer of thermal energy.

The heating unit 16 can include a heating pad 16a. The heating pad 16a can encapsulate or otherwise provide protection and/or support for the heating element 27. The heating element 27 can be concealed inside the heating pad 16a. The heating pad 16a can be made of various types of materials such as polyester, micromink, neoprene etc. In some embodiments, the material of the heating pad 16a is selected such that it provides adequate thermal conductivity to transfer the heat from the heating element 27 to the sport equipment 1. The heating pad 16a can protect the sport equipment 1 from directly contacting the heating element 27.

In some embodiments, the heating unit 16 includes the user interface 19, a conducting element 26, and a plug 17. The energy to operate the heating unit 16 can be an electrical current. The electrical current may be provided by a power source 18 to the heating element 27 through the plug 17, the conducting element 26, and the user interface 19. The conducting element 26 and the plug 17 may be located, for example, within the pocket 25 formed by the elastic fabric of the pocket face 12a to aid in the insertion of the plug 17 into the receptacle 30 on the power source 18.

The heating element 27 can receive its energy from the power source 18 through a hard wire connection, such as the conductor 26. For example, the heating element 27 can utilize the conductor 26 to transfer electricity from the power source 18 to the heating element 27. In some embodiments, the conductor 26 provides a physical mechanism to transfer the electricity from the power source 18 to the heating element 27, such as utilizing a wire, cable, combination of two or many wires and/or cables, or other conductor.

The plug 17 can be made to accommodate different connections based on the user's need. The plug 17 can provide a plug-and-play type connection where upon inserting the plug 17 into the receptacle 30, the heating unit 16 starts to communicate with the power source 18. For example, in some embodiments, the plug 17 can be made in the form of different types of Universal Serial Bus (USB) plugs, such as a mini USB, Micro-USB, USB Type A, USB Type B, USB Type C, USB 3.0, Lightning USB, or otherwise. The receptacle 30 in the power source 18 can have different forms to accommodate the corresponding plug connection. In some embodiments, wireless technology can be used to transfer power from the power source 18 to the heating element 27 of the heating unit 16, such as through inductive or capacitive coupling.

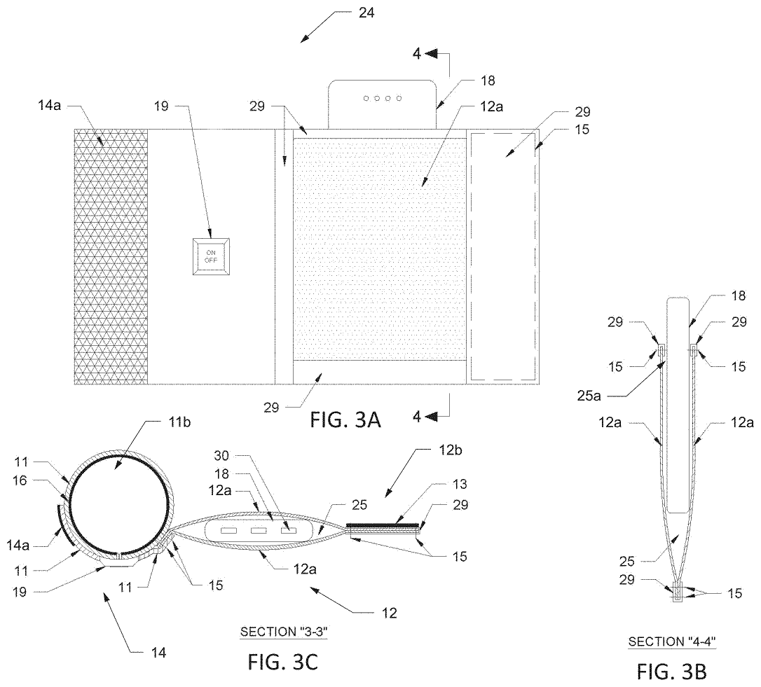

FIG. 3C and FIG. 4 show an embodiment of the heating unit 16 utilizing the conductor 26. After the user inserts the plug 17 into the receptacle 30, the user interface 19 allows the user to initiate the operation of the heating apparatus 10, which will result in the flow of electricity to the heating element 27 from the power source 18 through the conductor 26 and the user interface 19. In some embodiments, the plug 17 can be connected to the heating element 27 directly without having to go through the user interface 19. In some embodiments, the heating unit 16 and the power source 18 can have sensors to communicate wirelessly with the user interface 19, thus eliminating the need for the conductor 26 to physically connect the user interface 19 to both the heating element 27 and/or the power source 18. In some embodiments, the conductor 26 provides a physical connection from the user interface 19 to the power source 18, but the connection between the user interface 19 to the heating element 27 is made via wireless communication. In some embodiments, the conductor 26 provides a physical connection from the user interface 19 to the heating element 27, but the connection between the user interface 19 to the power source 18 is made via wireless communication. Certain embodiments include different arrangements of various elements of the heating unit 16.

### Mechanical Wrap

FIGS. 3A-3C show an embodiment of mechanical wrap 24 (also called the wrap). The wrap 24 can comprise one or plurality of fastening elements, such as straps, cords, bands, tie-downs, latches, clasps, elongate members, elastic members, inflatable bladders, or otherwise. In various embodiments, the wrap 24 is configured to compress (e.g., squeeze) the sleeve 11, heating unit 16, and/or sport equipment 1, as discussed in more detail below.

The mechanical wrap 24 can have a first end 14 and a second end 12. The first end 14 can be attached to the sleeve 11, such as to body 11a and/or the distal end. The connection of the first end 14 to the body 11a can be made via different types of mechanism. In some embodiments, a factory-made sewing mechanism can be used to make this connection, but other types of mechanisms can also be used to connect the first end 14 to the body 11a. In some embodiments, the first end 14 connects with the second end 12 utilizing an attachment piece 15 such that a portion of the second end 12 overlaps with the first end 14 and is sandwiched between the first end 14 and the body 11a. The first end 14 can have a loop 14a that together with a hook 13 forms a fastening system.

The second end 12 of the mechanical wrap 24 can be opposite the first end 14. The second end 12 can be a free end. The second end 12 can include the pocket 25. The pocket 25 can have the pocket face 12a on the inner or outer side. In various embodiments, the pocket 25 is flexible and/or integrated into the mechanical wrap 24. Integrating the pocket (e.g., between the interior and exterior walls, as shown in FIG. 3C), results in a larger volume of available space to hold most rechargeable battery packs that are commercially available. Additionally, such an integrated pocket can facilitate insertion and/or removal of the sport equipment 1 into the cylinder. The pocket 25 can be made of an elastic fabric, which can allow the wrap 24 to further expand and contract based on the size of rechargeable battery pack being used. This can facilitate or ensure consistent tension and compression of the heating element 27 against substantially the entire circumference of the sport equipment 1.

In some embodiments, the pocket 25 can have a closed bottom and a top 25a, such that the power source 18 can be passed through the top and not fall out of the bottom. The bottom of the pocket 25 can be closed using an end trim 29 which wraps around the two pieces of pocket face 12a. The attachment piece 15 can be used to connect the two pieces of 12a together at the bottom of the pocket 25. The top 25a can be an open top, a closed top, or a partially open top. In some embodiments, the top 25a can remain open to allow a user to insert or remove the power source 18. An open top 25a will also allow the user to have more options with regards to the size of the power source 18. For example, the user can place a large power source 18 into the pocket 25 while the open top configuration of top 25 will allow a portion of the power source 18 to extend out of the pocket 25. This arrangement allows a user to select power sources that are larger than the space available in the pocket 25.

In some embodiments, the top 25a is configured to be selectively closed. In some embodiments, the top 25a can be closed utilizing different mechanisms. For example, in some embodiments, the top 25a can have a zipper which will provide the user with an option to make on-demand decisions as to whether the top 25a should be closed or whether it should remain open depending on the user's needs. In some embodiments, the power source 18 is not located in the pocket 25, which will leave the space inside the pocket 25 available for other items. In some embodiments, the top 25a can be closed utilizing the end trim 29 and attachment piece 15, similar to the bottom of the pocket 25. The pocket face 12a can be manufactured from a wide array of materials. In some embodiments, the pocket face 12a is manufactured with elastic material to accommodate various sizes of the power source 18. In an embodiment where an elastic material is used to manufacture the pocket face 12a, the elastic characteristic of the pocket face 12a will allow the two sides of the pocket face 12a to gently compress against the power source 18 and can help with stabilizing and securing the power source 18 in the pocket 25.

The overall length of the second end 12 can vary. The second end 12 can be configured to wrap around the circumference of the sleeve 11 with the sport equipment 1 installed. In some embodiments, the overall length of the second end 12 is designed to allow the hook 13 to reach the loop 14a to secure the second 12 to the first end 14, and to compress the heating element 27 against the sport equipment 1. In some embodiments, the hook 13 and the loop 14a fastening system can be a Velcro® fastener system. The hook 13 and the loop 14a can be made of any suitable material that allows for the hook 13 to attach to the loop 14a. In some embodiments, the hook 13 and the loop 14a can be constructed with nylon and polyester.

In some embodiments, the second end 12 can have an end portion 12b. The end portion 12b can include the hook 13, which can be secured in place utilizing the attachment piece 15. In some embodiments, the extension of the pocket face 12a continues to the end portion 12b and overlaps with the hook 13. The end trim 29 can be used to wrap around the two sides of the pocket face 12a. The attachment piece 15 can be used to secure the hook 13, the end trim 29, and the two sides of the pocket 12a in the end portion 12b.

FIGS. 3A-3C show the power source 18 placed inside the pocket 25 of the mechanical wrap 24. The power source 18 can be a power bank, such as a battery. In some embodiments, the power source 18 can be procured by the user separately based on the user's preference. This provides the flexibility to the user to select from a variety of conventional portable power banks with different capacities and/or different milliampere-hour (mAh). For example, the power source 18 can have a capacity of about 10,000 mAh or about 20,000 mAH or about 30,000 mAh or about 38,800 mAh or any capacity smaller than about 10,000 mAH or larger than 38,800 mAh or any capacity between 10,000 mAh and 38,800 mAh. A frequent user of the heating apparatus 10, or a user who plans to use the heating apparatus 10 for an extended period or in a particularly cold climate, may select a type of power source 18 that has a larger capacity. An infrequent user, or a user who plans to use the heating apparatus 10 for only a short period or in a milder climate, may select the power source 18 that has a smaller capacity. Thus, the heating apparatus 10 can be adapted based on the user's desired choice and planned usage. The power source 18 can provide different power outputs, such as about 5V/2.1A or about 5V/3A or any other output smaller than about 5V/2.1A or larger than about 5V/3A or any number in between about 5V/2.1A and about 5V/3A. As noted earlier, different choices of the power source 18 can provide the user with an option to select the adequate type of power source based on their needs or plans. The availability of different types of power source 18 will also provide the user with the option to select a type of power source based on the user's choice of the required heating time.

### User Interface

As mentioned above, the heating apparatus 10 can include the user interface 19. The user interface 19 can include an on/off function that allows the user to turn the heating unit 16 on or off by initiating or stopping the flow of power to the heating unit 16. In some embodiments, the user interface 19 can have a functionality to automatically turn the flow of electricity to heating unit 16 on or off. For example, the user interface 19 can provide heating to the sport equipment 1 until a setpoint temperature is achieved.

In some embodiments, the user interface 19 can be a physical on/off button, switch, toggle, or the like. In some embodiments, the user interface 19 can include a touchscreen or other digital display, such as to allow the user to turn the heating unit 16 on/off by touching the display of the user interface 19. In some embodiments, the user interface 19 can provide other information that aids the user in operation of heating apparatus 10. For example, the user interface 19 can signify to the user that the power source 18 is nearing or has been depleted and may need recharging or replacement. In some embodiments, the user interface 19 is configured to receive a variable input from the user, such as a setpoint temperature. For example, the user interface 19 can include a capacitive touch input to enable the user to input the setpoint temperature or other data. The heating apparatus 10 can include sensors to detect the temperature of the sport equipment 1, of the heating pad 16a, of ambient, etc. In some embodiments, the user interface 19 can display the temperature of the sport equipment 1, heating pad 16a, setpoint temperature, and/or ambient temperature, etc. In some embodiments, user interface 19 can include a control unit with a sensor that detects the presence of the sport equipment 1 inside the sleeve 11. In some embodiments, presence of the sport equipment 1 inside the sleeve 11 is a necessary condition before the heating apparatus 10 will active the heating unit 16.

In some embodiments, the user interface 19 can include a control unit, such as an electronic processor and a memory. The controller can be in operative communication with the sensors and/or the heating unit 16. The controller can control the heating output of the heating unit 16, such as to achieve a setpoint temperature. The control unit can allow for wireless communication of the user interface 19 with an external device, such as a mobile device (e.g., smartphones, tablets, etc.) using a Bluetooth or other wireless communication protocol, which allows the user of a mobile device to communicate with the heating apparatus 16 by utilizing an application executed on the mobile device. The controller can wirelessly output information to the mobile device (e.g., bat temperature, battery used or remaining, time used or remaining, etc.) and/or receive inputs from the mobile device (e.g., temperature setpoint, shutdown, etc.).

### Operation

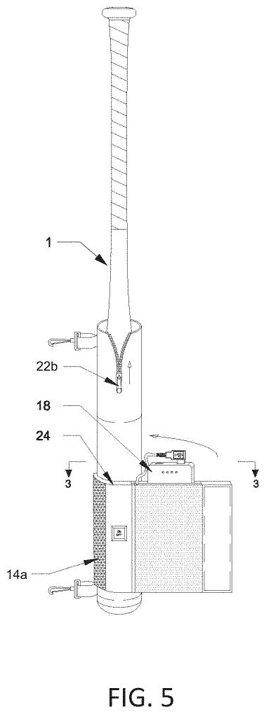

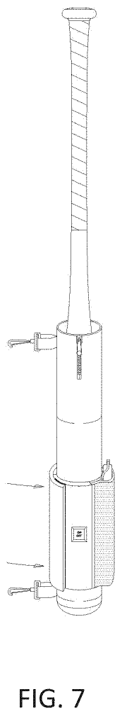

FIGS. 5, 6, and 7 illustrate an embodiment of the heating apparatus 10 in various stages of operation. Beneficially, the heating apparatus 10 can be convenient and/or easy to use. As shown in FIG. 5, the sport equipment 1 can be inserted into the cavity in the sleeve 11. To facilitate such installation, the fastening piece 22 (e.g., zipper) can be moved to the open position. The user can leave the fastening piece 22 in the open position or move it to the closed position, which may contain reduce heat loss, speed warming, increase battery life, reduce temperature fluctuations, etc. Before or after the sport equipment 1 is inserted into the cavity, the user can slide a power source 18 into the pocket 25. The user can insert the plug 17 into the receptacle 30 to ensure the power source 18 can provide power.

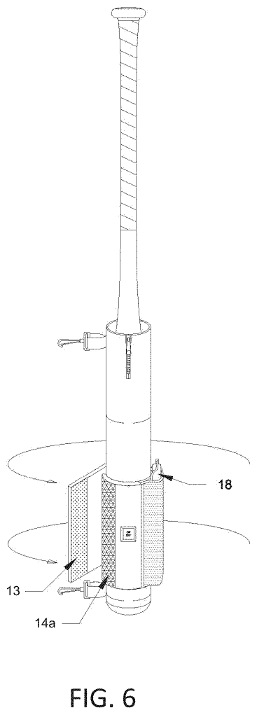

As illustrated in FIG. 6, the user can wrap the mechanical wrap 24 around the exterior of the sleeve 11. The user can pull on the second end 12 of the wrap 24 to apply compressive force to the sleeve 11, the heating unit 16, and/or the sport equipment 1. The mechanical wrap 24 can be secured (e.g., to itself) using the hook 13 and loop 14a fastener system. The availability of the hook 13 and loop 14a or another fastener system allows the user to apply and maintain additional compressive pressure on the sport equipment 1, thus providing more direct heat to the sport equipment 1.

Various embodiments are configured to provide multiple stages or mechanisms of compression of the heating unit and the sport equipment 1. The compressive characteristic of the body 11a can provide a first stage or mechanism of mechanical compression of the heating unit 16 against and/or toward the sport equipment 1. The wrapped and secured mechanical wrap 24 can provide a secondary stage or mechanism of mechanical compression of the heating unit 16 against and/or toward the sport equipment 1. The multiple stage or mechanism approach can facilitate or ensure adequate (e.g., substantially continuous and/or continuous) contact between the heating unit 16 and the sport equipment 1 and/or of the transfer of thermal energy from the heating element 27 to the sport equipment 1. For example, good contact between the heating unit 16 and the sport equipment 1 can be provided despite the bat being dirty, nicked, dented, out-of-round, or otherwise having imperfections.

The body 11a and wrap 24 can provide similar or different amounts of compression to the sport equipment 1. In some embodiments, the amount of compressive force provided by the mechanical wrap 24 against and/or towards the sport equipment 1 is more than the amount of compressive force provided by the body 11a. For example, the mechanical wrap 24 can provide a compressive force that is greater, compared to the compressive force provided by the body 11a, by at least about: 10%, 25%, 50%, 150%, 250%, 500%, or more. In some embodiments, the mechanical wrap 24 can provide compression that is or about 100% or about 200% or about 300% more than the compression provided by the body 11a. In some embodiments, the compression wrap 24 can provide compression that is at least about 30% and/or less than or equal to about 300% of the compression provided by the body 11a, or any percentage between about 30% and about 300%. In some embodiments, the body 11a can provide more compressive force than the mechanical wrap 24. In some embodiments, the body 11a and warp 24 provide approximately the same compressive force to the sport equipment 1.

After the mechanical wrap 24 is secured, the user can activate the heating unit 16 using the user interface 19. For example, in some embodiments, the user presses the user interface 19 to illuminate it, indicating the heating apparatus 10 is in operation and applying heat to the sport equipment 1. The heating apparatus 10 can continue to apply heat to the sport equipment 1 until the user is ready to use the sport equipment 1, or until a condition is satisfied (e.g., a temperature setpoint is reached, a preset amount of time has elapsed, etc.). When the user is ready to use the sport equipment 1 (such as when the user is on deck, up next, or up to bat), the user can extract the now-warmed sport equipment 1 from the sleeve 11 through the opening 22. In some embodiments, the user also moves the fastening piece 22a to the open position before extraction. In certain embodiments, the heating apparatus 10 can apply heat to the sport equipment 1 regardless of the fastening piece 22a position. The user can release the second end 12 of the wrap 24 from the sleeve 11, such as by separating the hook and look fastening system, to reduce or remove the compression of the wrap 24 on the sleeve 11, heating unit 16, and/or sport equipment 1. After the user has batted or otherwise used the sport equipment 1, he or she may re-insert the sport equipment 1 into the heating apparatus 10, as discussed above.

A user has the option to hang the heating apparatus on a structure, such as a chain-link fence, using the connectors 20. This can enable the user to orient the heating apparatus 10 in a generally vertical, generally horizontal, or other orientation. The user also has the option to place the heating apparatus 10 on the ground.

When the heating apparatus 10 is not in use, the user can store the heating apparatus 10, with the sport equipment 1 fully inserted into the cavity, in a standard equipment bag, like backpack, roller bag, or tote bag styles. In some embodiments, the sleeve 11 can be rolled, folded, or compressed into the mechanical wrap 24. In such a configuration, the entire heating apparatus 10 can be reduced to merely the size of the mechanical wrap 24.

### EXAMPLES

A Louisville Slugger LXT FPLXD10-21 bat made from carbon composite material was installed into the heating apparatus 10 and the heating apparatus 10 was activated. The bat was about 31 inches long and weighed about 21 ounces. The temperature of the bat inside the heating apparatus 10 was recorded after 10 minutes, 20 minutes, 30 minutes, and 60 minutes, as shown in Table 1 below:

TABLE 1

| Time | Temperature (approx.) |
|---|---|
| 10 minutes | 106° F. |
| 20 minutes | 121° F. |
| 30 minutes | 134° F. |
| 60 minutes | 150° F. |

A Louisville Slugger LXT FPLXD10-21 bat made from carbon composite material was installed into the heating apparatus 10 for 60 minutes, then removed from the heating apparatus 10 and placed in an ambient environment of about 72° F. The bat was about 31 inches long and weighed about 21 ounces. After removal, the temperature of the bat was recorded at 4 minutes, 8 minutes, 12 minutes, and 16 minutes, as shown in Table 2 below:

TABLE 2

| Time | Temperature (approx.) |
|---|---|
| 4 minutes | 114° F. |
| 8 minutes | 103° F. |
| 12 minutes | 94° F. |
| 16 minutes | 88° F. |

Without being limited to a particular theory, it is believed that the heating coils efficiently distribute heat deep inside the bat, which results in complete coverage of the action zone of the barrel and greater retention of heat after the bat is removed from the heating apparatus 10.

### Certain Terminology

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations. The term “vertical” refers to an orientation parallel to the Earth's gravity.

Conditional language, such as “can,” “could,” “might,” or “may,” unless specifically stated otherwise, or otherwise understood within the context as used, is generally intended to convey that certain examples include or do not include, certain features, element and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 100% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

### SUMMARY

Several illustrative examples of portable devices and systems for warming sports equipment have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of the steps, processes, structures, and/or devices disclosed or illustrated in one example in this disclosure can be combined or used with (or instead of) any other portion of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of portable devices and systems for warming sports equipment and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above, but should be determined only by a fair reading of the claims.

The following is claimed:

1. A bat warmer comprising:
a sleeve configured to receive a bat;
a heater on an interior of the sleeve, the heater configured to apply thermal energy to the bat in the sleeve; and
a wrap comprising a first end and a second end, the first end connected to the sleeve, the second end opposite the first end and being configured to wrap around an exterior of the sleeve such that the wrap applies compressive force to the sleeve, the heater, and the bat in the sleeve.

2. The bat warmer of claim 1, wherein the first end comprises one of a hook and a loop, the second end comprises the other of the hook and the loop, the hook and the loop forming a fastening system to connect the wrap to itself.

3. The bat warmer of claim 1, wherein the sleeve is made from neoprene.

4. The bat warmer of claim 1, wherein the heater directly contacts the bat.

5. The bat warmer of claim 1, wherein the second end comprises a pocket and configured to receive a battery for powering the heater.

6. A combination comprising the bat warmer of claim 1 and the bat.

7. A heating apparatus for warming a sport equipment, the heating apparatus comprising:
an electric heater configured to apply thermal energy to the sport equipment during operation of the heating apparatus;
a battery operably connected to the electric heater so as to provide electric power to the electric heater during operation of the electric heater;
a compression sleeve configured to receive the sport equipment and to provide a first stage of force to press the electric heater against the sport equipment; and
a wrap comprising a first end attached to the compression sleeve and a free second end opposite the first end, the wrap configured to provide a second stage of force to press the electric heater against the sport equipment.

8. The heating apparatus of claim 7, further comprising a user interface connected to the electric heater, the user interface designed to control an operation of the electric heater in response to an input by a user.

9. The heating apparatus of claim 7, wherein the compression sleeve comprises a top end with an opening and an adjustable fastening system configured to adjust a size of the opening.

10. The heating apparatus of claim 7, wherein the electric heater is positioned in an interior of the compression sleeve.

11. The heating apparatus of claim 7, wherein the free second end of the wrap connects to the first end of the wrap when the heating device is in use.

12. The heating apparatus of claim 7, wherein the electric heater is pressed directly against the sport equipment.

13. The heating apparatus of claim 7, wherein the sport equipment is a baseball bat or softball bat.

14. The heating apparatus of claim 8, wherein the user interface illuminates when the electric heater is in use.

15. The heating apparatus of claim 9, wherein the adjustable fastening system is a zipper.

16. A combination comprising the heating apparatus of claim 7 and the sport equipment.

17. A sport equipment warming assembly comprising:
a compression sleeve configured to receive a generally cylindrical portion of a sport equipment, the compression sleeve comprising a bottom portion, a top portion, and a middle portion connecting the top portion to the bottom portion;
a heater connected with the compression sleeve; and
a wrap comprising:
a first end attached to the middle portion of the compression sleeve; and
a second end opposite the first end, wherein the second end is configured to wrap around the compression sleeve, the heater, and the generally cylindrical portion of the sport equipment and to attach to the first end.

18. The sport equipment warming assembly of claim 17, wherein the second end comprises a pocket.

19. The sport equipment warming assembly of claim 18, further comprising a battery positioned in the pocket, the battery configured to provide electric power to the heater.

20. The sport equipment warming assembly of claim 17, wherein the heater abuts the generally cylindrical portion of the sport equipment.
